(19) United States
(12) Patent Application Publication
(10) Pub. No.: US 2021/0277696 A1
(43) Pub. Date: Sep. 9, 2021

(54) HINGE DEVICE FOR APPLIANCES WITH TOP LOADING

(71) Applicant: C.M.I. CERNIERE MECCANICHE INDUSTRIALI S.R.L., VALSAMOGGIA (BO) (IT)

(72) Inventor: Eros Gherardi, Bologna (IT)

(21) Appl. No.: 16/335,784

(22) PCT Filed: Sep. 15, 2017
(86) PCT No.: PCT/EP2017/073371

§ 371 Date: Mar. 22, 2019

(30) Foreign Application Priority Data
Sep. 22, 2016 (IT) 102016000095316

(51) Int. Cl. E05F 1/12; E05F 1/10

(52) U.S. Cl. CPC E05F 1/1269; E05F 1/1066; E05Y 2900/31; E05Y 2800/75; E05Y 2900/312; E05Y 2201/264

(57) ABSTRACT

A connection pin (10) is connected to a shaped body (13) having a roll (14) and a coupling (16) for and end of a spring (17) acting in the opening direction. A shaped guide (19) has a path portion (21) with first and second extremities and having at least a recess (24) placed between the extremities where the roll abuts with the path portion and moves along it in the opening stroke starting from the closed condition, when the roll means (14) abuts a first extremity. The roll reaches a metastable opening condition where it is in and abuts the recess facing the second extremity until, due to a thrust towards the opening direction sufficient to leave the recess (24), the roll (14) reaches the condition of extreme opening in which it abuts against a second extremity and vice versa in the closing stroke.

### BACKGROUND

The present invention relates to the field of household appliances and furniture and it refers to a hinge device for top loading or top entrance appliances particularly fit for household appliances, such as driers, washing machines, chest refrigerators and like appliances equipped with a door with a horizontal hinge axis and with the door arranged to be horizontal in its closed condition.

Said hinge device is assigned to allow the door rotations or opening and closure strokes respectively from its closed condition to its extreme open condition and vice versa where such rotation from the closure to the extreme opening is preferably 86°-90°, but it can be smaller or bigger.

Hereafter in the present document, with the term “stroke”, e.g. opening and closure stroke, we refer to the rotation or to the movement of a member of the hinge device around a rotation pin of the device itself or along a trajectory with contextual rotation of a door or hatch of the household appliance where such door is fixed to said member; the stroke is thus to be intended as circular and centred around a pin or along a different rectilinear curved or any trajectory.

Hinge devices are known for closure doors or hatches for appliances with top loading provided with springs for weight balance of the door.

A disadvantage of such known hinge devices consists in the fact that they do not allow the door to assume a middle opening position and they seem to be stable only in the closure and extreme opening conditions.

Another disadvantage of said known devices consists in the fact that they allow a good weight balance of the door allowing the opening with low effort but they carry the movable portion of the device fixed to the door of the appliance to hit its own opening lock or stop with an excessive speed causing collisions and risks of damages of the device and of the respective appliance or they guarantee a final low speed opening stroke but they need a great effort at least during the initial opening stroke.

Other disadvantages of some known devices consist in the excessive complexity and/or cost or in the insufficient sturdiness and reliability.

Document WO 2015/086470 A1 discloses a hinge device for appliances with top loading having a first fixing means assigned to be fixed to a body or framework of an appliance and pivotally connected, by means of a hinge pin, to a second fixing means assigned to be fixed to a top door or hatch of the appliance to allow the opening and closing strokes between extreme opening and closing conditions of said door in respect to the same appliance where, in an operative condition, the rotation axis of said hinge pin and the plane of the door in the closed condition are horizontal or substantially horizontal. The second fixing means is provided with a first connection pin parallel to and spaced from the hinge pin and connected to an end of a transmission means whose opposite end has a second connection pin parallel to the first connection pin and connected to a shaped body means comprising at least a roll means and a coupling means for an end of a resilient means acting at least in a direction according to the opening direction. Said known device further comprises a shaped guide means having a path portion delimited between a first extremity and a second extremity thereof. The roll means abut with said path portion and moves along it in the opening stroke starting from the closed condition until, due to a thrust towards the opening direction, it reaches the condition of extreme opening in which it abuts against the second extremity and vice versa in the closing stroke.

A similar device is disclosed by document US 2010/229344 A1.

### SUMMARY

An object of the present invention for a hinge device for appliances with top loading, consists in allowing the door to reach one or more middle opening positions which are labile but sufficiently stable, i.e. they are metastable for example to manually position the door in an outflow condition of the vapor generated inside the appliance, for instance after a stroke of almost 5° from the closure condition, and it allows to maintain such outflow condition until a manual intervention by an operator occurs to carry the door into its extreme opening condition or into the closure one.

Another object is to propose a hinge device which can, at the same time, provide a good weight balance of the door and it allows control of the speed in the final portion of the opening stroke so as to avoid excessive collisions and risks of damages.

Other objects are to propose a hinge device quite simple, easy-to-shape to solve different operative needs, economic, robust and reliable.

### BRIEF DESCRIPTION OF DRAWINGS

The features of the invention are below underlined with particular reference to the attached drawings in which:

FIGS. 1 and 2 show side views of the hinge device for appliances with top loading, object of the present invention, in which a first fixing means is fixed to a body or frame of the appliance and in which a second fixing means is fixed to a door or upper hatch of the appliance, in conditions respectively closed and opened, where such body and door are partially illustrated;

FIG. 3 shows an enlarged view of the device of FIG. 1 in a condition of partial opening and in which some parts have been removed to underlined another;

FIG. 4 shows an enlarged particular of FIG. 3;

FIGS. 5, 6, 7, 8, and 9 show orthogonal projection views of the device of FIG. 1 in closure condition respectively from one side, rear, frontal, from the bottom and from the top;

FIGS. 10 and 11 show axonometric views and from opposite sides of the device of FIG. 1 in closed condition;

FIGS. 12 and 13 show axonometric views and from opposite sides of the device of FIG. 1 in open condition;

FIG. 14 shows a side, partial and enlarged view of a particular of the preceding figures in end of the opening stroke slowdown, represented by a continuous line, and at the extreme opening or almost, by a dashed line;

FIG. 15 shows an axonometric and exploded view of the device of FIG. 10.

### DETAILED DESCRIPTION

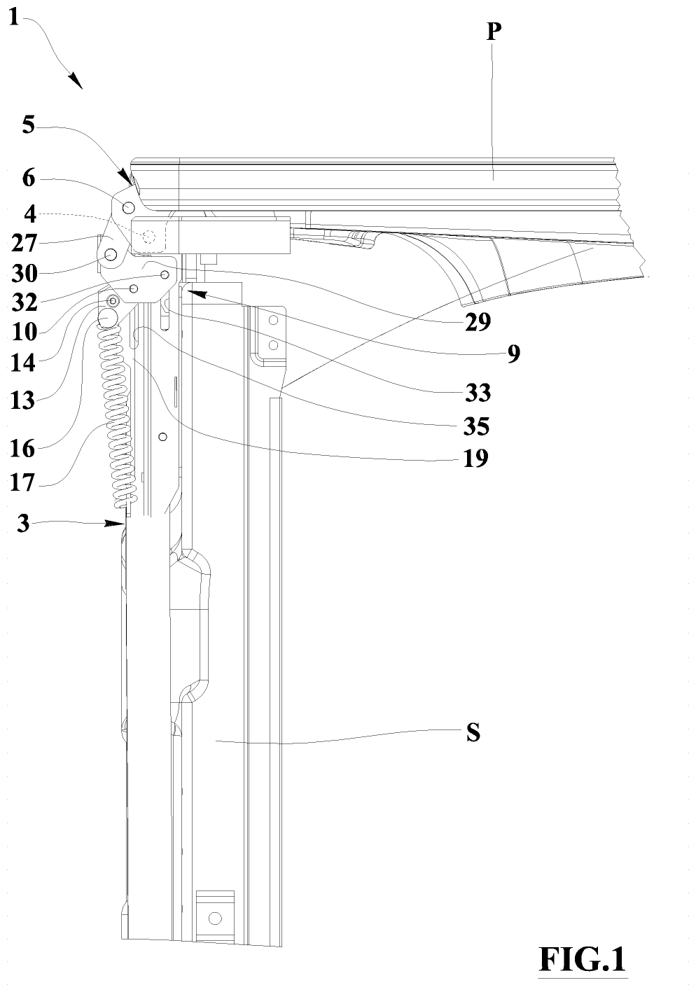

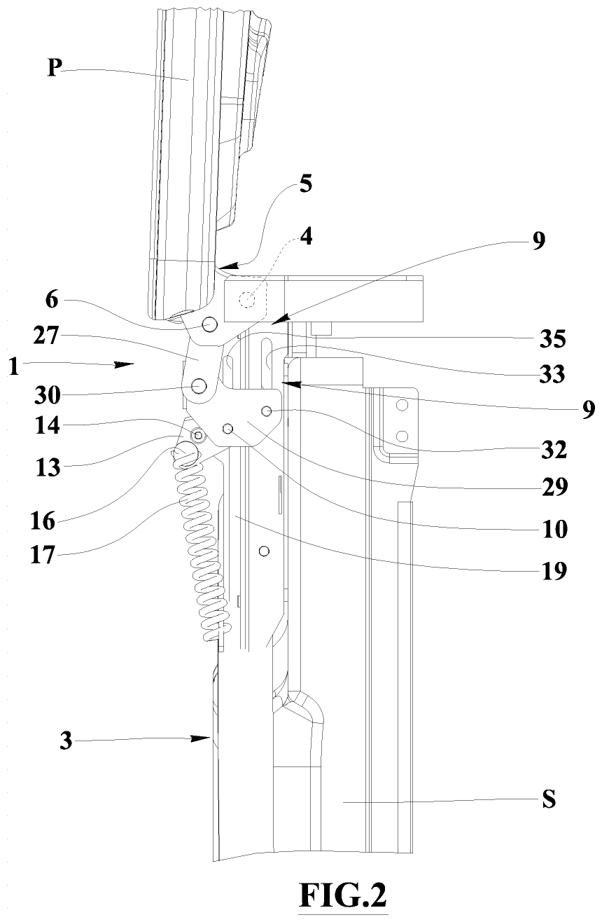

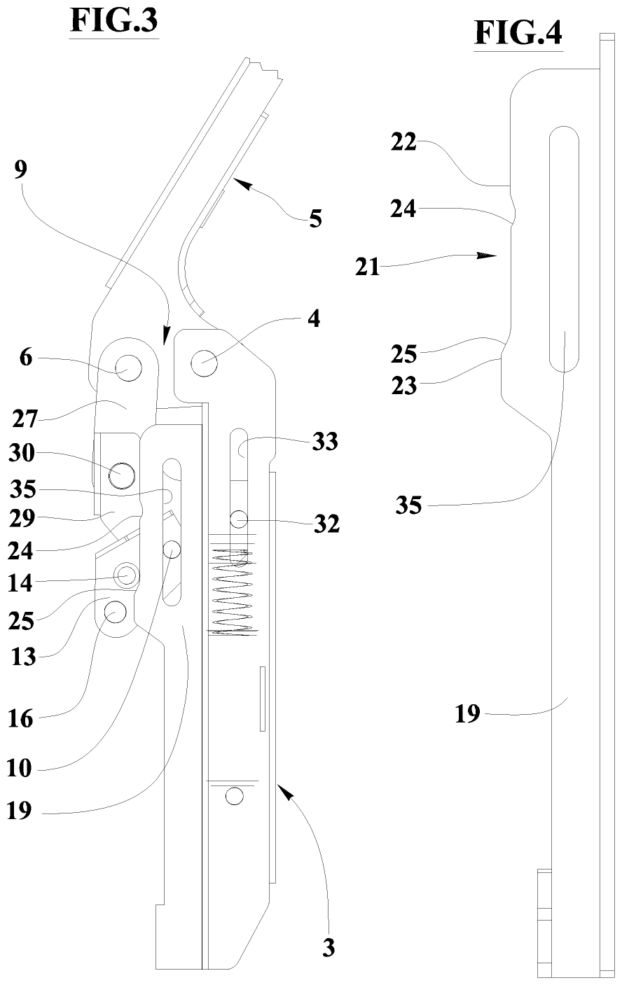

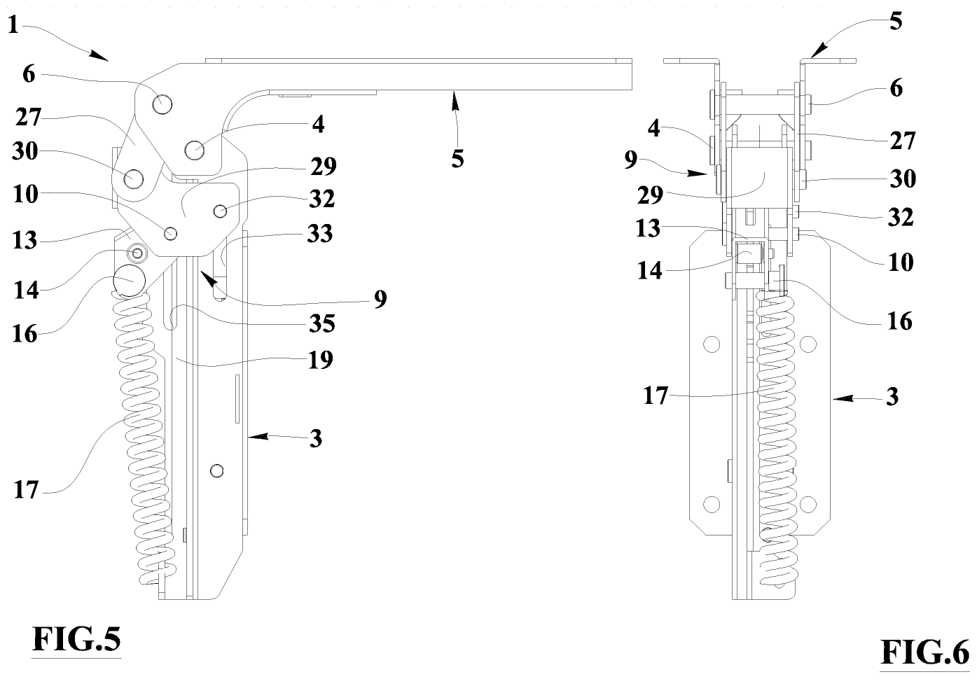

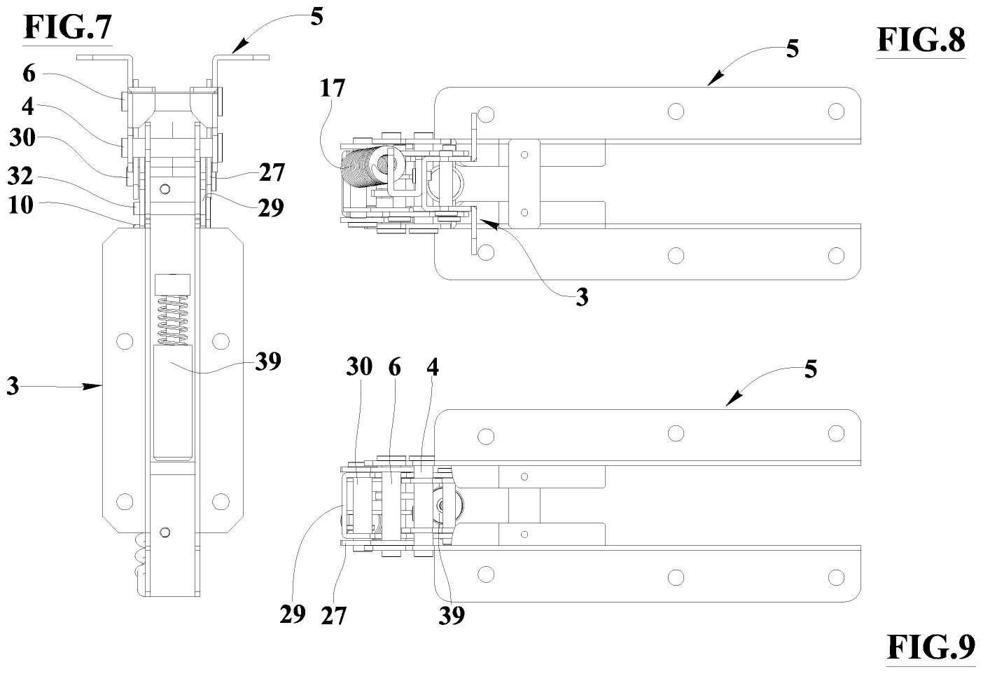

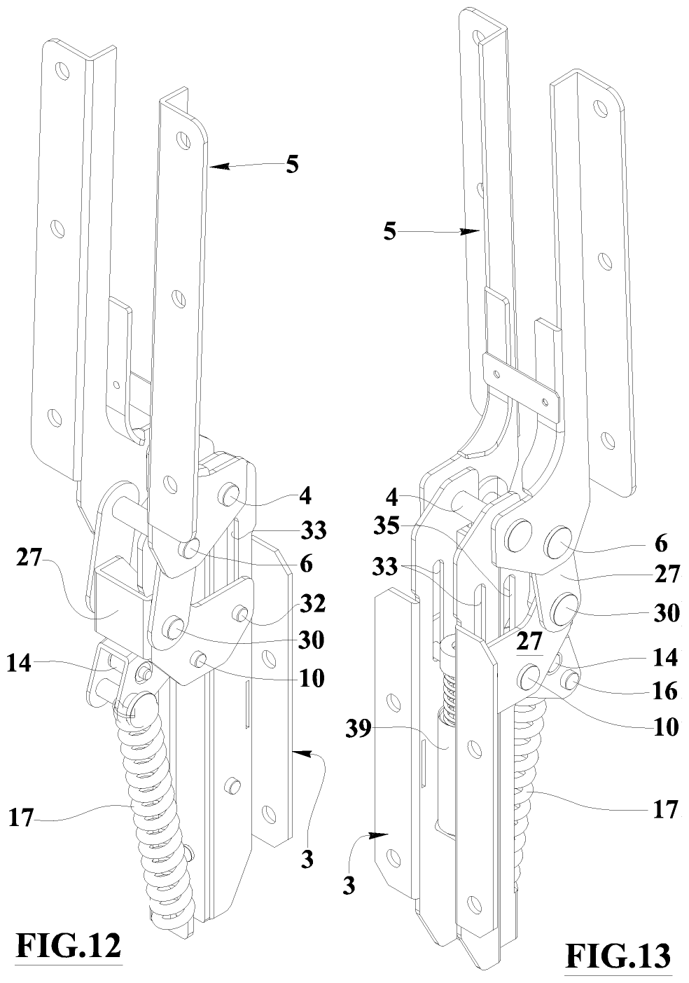

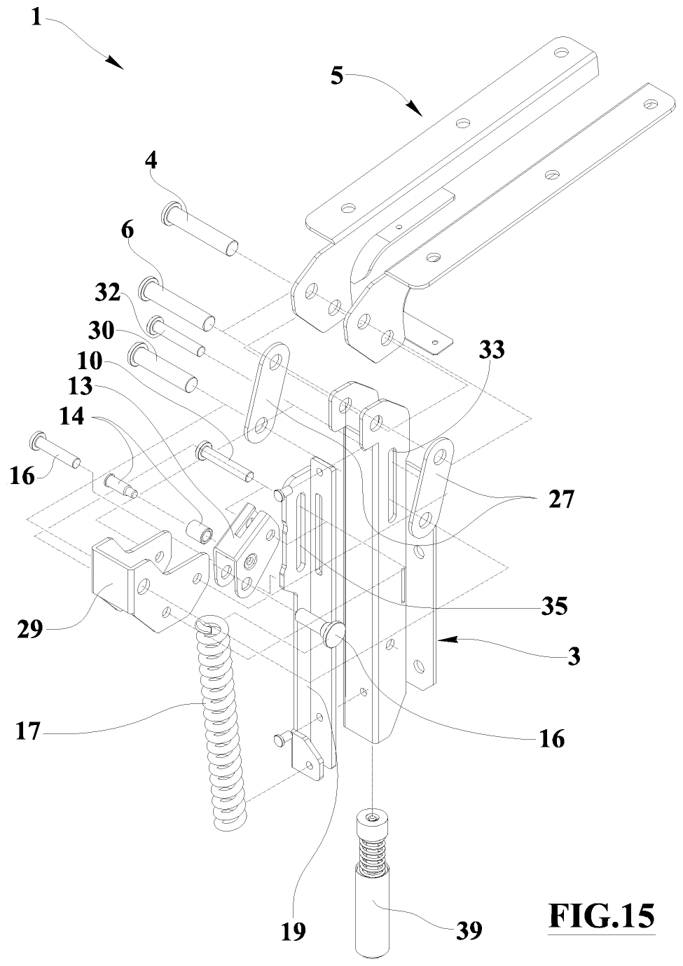

With reference to the FIGS. 1-15, numeral 1 indicates the hinge device for appliances with top loading, according to the present invention.

The hinge device for appliances with top loading is equipped with a first fixing means 3 assigned to be fixed to a body S, framework or structure of an appliance, for example a dryer for clothes with top loading. The first fixing means 3 is connected in a rotating way by means of a hinge pin 4 to a second fixing means 5 assigned to be fixed to an upper door P or hatch of the appliance to allow the opening and closure strokes between conditions of extreme opening and closure and vice versa of said door with respect to the corresponding opening of the appliance.

In an operative condition of the appliance, the rotation axis of said hinge pin 4 is horizontal or substantially horizontal and the geometric plane defined by the door, in the closure condition, is horizontal or substantially horizontal. Hereafter the terms orientation, inclination or opening of the door are meant to be referred to the geometric plane defined by the door itself.

Preferably the door P is articulated to the body S by means of a plurality of devices 1, for example in the number of two.

The second fixing means 5 is equipped with a first connection pin 6 parallel and spaced from the hinge pin 4 and connected to an end of transmission means 9 whose opposite end has a second connection pin 10 parallel to the first connection pin 6 and connected to a “U” shaped body means 13 made of sheared and U-bended metal sheet.

The first fixing means 3 and the second fixing means 5 are preferably made of sheared and U-bended metal sheet and each has a couple of parallel ears. The ears of the first fixing means 3 have a couple of facing seats to house the hinge pin 4; the ears of the second fixing means 5 have two couples of seats, one for the hinge pin 4 and one for the first connection pin 6.

Such transmission means 9 are assigned to transfer between the second fixing means 5 and the “U” shaped body means 13 the motion generated by the stroke of the door and the forces interacting between such means 5, 13.

By way of example, the seats carried out in the ears of the second fixing means 5 are arranged in such a way that, in the closed condition, the first connection pin 6 is placed outward of the appliance and upward of the hinge pin 4. During the opening stroke, the first connection pin 6 delineates an external arc centered on the hinge pin 4 and it goes down passing below the hinge pin 4 and vice versa in the closure stroke during which a spring of a resilient means 17 is lengthened providing a resilience force acting in opposition to the closure motion itself.

The “U” shaped body means 13 comprises at least one roll means 14, e.g. consisting of a bearing or wheel which is mounted in a freely rotating way on a respective pin which acts as a rotation axis and whose ends are fixed to respective side faces of the “U” shaped body means 13 itself.

The “U” shaped body means 13 furthermore comprises a coupling means 16 for an end of the resilient means 17 acting at least in a direction according to the opening.

The coupling means 16 can consist, for example, of a pin, a hook or bar engaged by a terminal eyelet or hook of the spring of the resilient means 17 consisting, for example, of a helical spring acting in traction.

The end of the resilient means 17 opposite to the coupling means 16 is fixed, by means of a pin, a hook, bar or protrusion, to the first fixing means 3.

Said device 1 furthermore comprises a shaped guide means 19 having a path portion 21, for example consisting of a shaped edge of the shaped guide means 19, delimited by a first extremity 22 and a second extremity 23 and having a recess means 24 placed between said extremities 22, 23 where the roll means 14 matches with said path portion 21 and moves along the path portion 21 in the opening stroke between the closure condition, in which the roll means 14 matches with the first extremity 22, reaching a condition of metastable opening in which the roll means 14 is in the recess means 24 and matches with the edge of the recess means 24 on the side of the second extremity 23, and to reach, after a push up towards the opening which is sufficient to get the roll means 14 out of the recess means 24, and then to the extreme opening condition in which the roll means 14 matches with the second extremity 23 of the path portion 21 and vice versa in the closure stroke.

Alternatively, the invention provides for the path portion 21 to be equipped with a plurality of recess means 24, each assigned to realize a corresponding metastable position of the door.

The middle profile of the path portion 21 is nearly rectilinear and the resilient means 17, by means of a coupling means 16, transfers to the “U” shaped body means 13 an elastic force having a component acting in the direction according to the opening stroke and a component directed to the path portion 21 and acting on the roll means 14 pressing it in a resilient way towards the path portion 21. For example, in the operative condition, the component acting in the direction according to the opening stroke is vertical and the component bound for the path portion 21 is horizontal and turned towards the shaped guide means 19 which in turn is nearly vertical.

Said middle profile is nearly rectilinear and thus nearly parallel to said direction according to the opening stroke at least.

The shape of the recess means 24 of the path portion 21 is preferably asymmetrical and has a first portion, near the first extremity 22, nearly rectilinear having a certain inclination with respect to the middle profile of the path portion 21, for example 10°-25°, a second intermediate or end portion, with convex arc shape, and a third portion inclined in opposed direction with respect to the first one and having a larger angle, for example 15°-35°.

The path portion 21 of the shaped guide means 19 is furthermore equipped with a protruding ramp means 25 placed near the second extremity 23 where the roll means 14 reaching and going along such protruding ramp means 25 in the opening stroke dampens or stops the speed of the door motion.

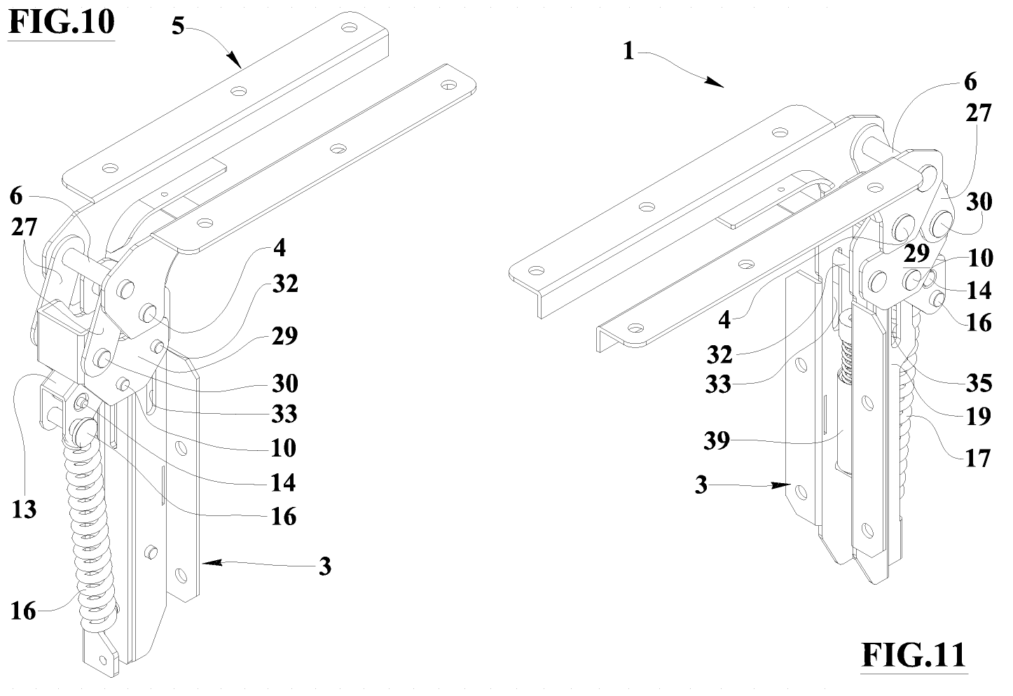

The transmission means 9 comprises at least one connecting rod 27, preferably constituted by a couple of elongated, rectilinear and parallel metal plates (see for instance FIG. 10), each having a first rod end directly connected to the first connection pin 6 and each having a second rod end connected, by means of an intermediate rotation pivot 30, to an end of an arm means 29 made of punched and U-bent metal sheet.

A middle portion of the arm means 29 is connected in a rotating way to the second connection pin 10.

The arm means 29 of the transmission means 9 and the “U” shaped body means 13 are thus mutually articulated by means of the second connection pin 10 and the arm means 29 partially contains such “U” shaped body means 13.

A portion of the arm means 29 furthermore has a strike gudgeon means 32 which slides in a first slot means 33 nearly rectilinear carried out in or fixed to the first fixing means 3 and nearly parallel to the path portion 21.

The second connection pin 10, intermediate rotation pivot 30 and the strike gudgeon means 32 are disposed, for example, at the vertices of a geometric triangle.

Alternatively, the invention provides for the connecting rod 27 not to have the intermediate rotation pivot 30 and to be equipped, instead of it, with the second connection pin 10 realizing a direct link with the “U” shaped body means 13.

In both cases, the second connection pin 10 slides in a second slot means 35 nearly rectilinear and carried out in the shaped guide means 19 parallel to the path portion 21. As an option, the device 1 can furthermore comprise a dampener means 39, for example of small linear type cylinder nearly parallel to the first slot means 33. An end of the dampener means 39 is fixed to the first fixing means 3 and a remaining movable end of the dampener means 39 is assigned to match with the strike gudgeon means 32 at least in a terminal portion of the stroke of the door rotation.

The shaped guide means 19 consists preferably of a punched and bent metal sheet or plate and the edge of the path portion 21 is preferably smooth or sleek and eventually hardened.

The operation of the device starting from its closed condition of the door P, in which the roll means 14 corresponds with the first extremity 22 of the path portion 21 of the shaped guide means 19 and the door is oriented at 0°, provides for the application of a sufficient manual force to be applied to the door, acting in the direction of the opening and helped by the spring of the resilient means 17, to provoke the rotation of the door and the beginning of the opening stroke during which the roll means 14 rolls or slides along an initial rectilinear portion of the path portion 21. After almost 5° of rotation of the door, the roll means 14 enters the recess means 24 where it matches with the edge oriented towards the second extremity 23, i.e. with the third inclined portion of the recess means 24, assuming a metastable condition of partial opening. Without closure or opening forces sufficient to let the roll means 14 to go out from the recess means 24, the device maintains such metastable opening condition of almost 5° inclination of the door.

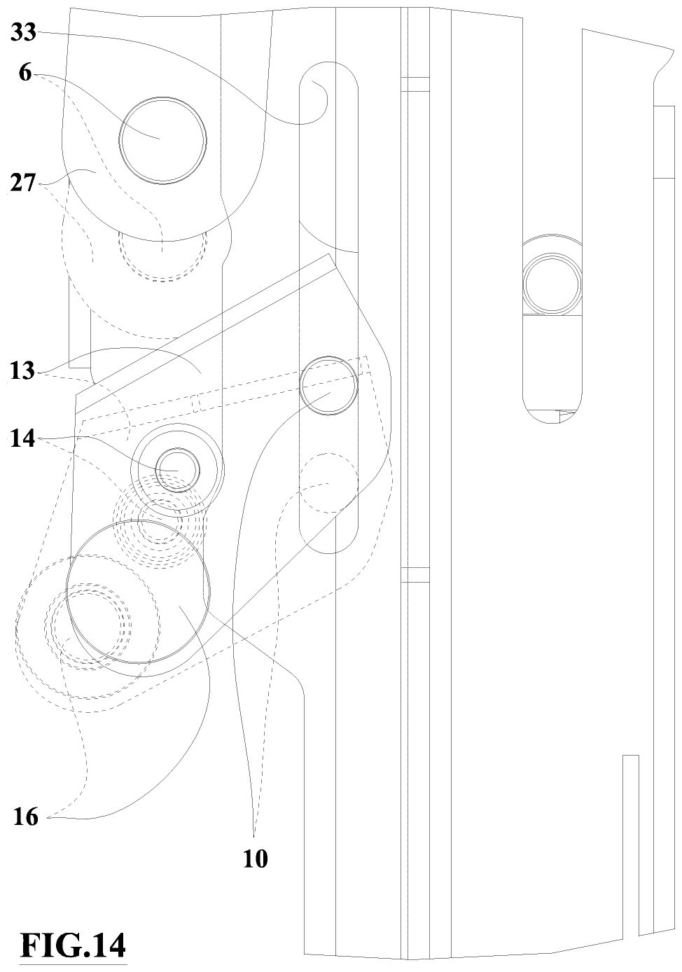

The manual application of a sufficient opening force, causes the exit of the roll means 14 from the recess means 24 and the rotation of the door in an opening stroke during which the roll means 14 slides along the intermediate rectilinear portion of the path portion 21 and the spring of the resilient means 17 shortens while relaxing until the door reaches an opening of 75°; in correspondence with such last opening angle, the roll means 14 matches with the protruding ramp means 25 whose inclination causes a rotation of the “U” shaped body means 13, shown in FIG. 14, and a lengthening of the spring which thus applies an inverted force opposing to the opening thereby slowing down its stroke so that, some degrees later, the roll means 14 leaves the protruding ramp means 25 and goes along a rectilinear terminal portion of the path portion 21 until reaching the second extremity 23 in which the door is in its extreme opening condition for example of almost 88°. Such rectilinear portions initial, middle and terminal of the path portion 21 define the direction of the middle profile of this path portion 21 and are parallel to the first slot means 33 and second slot means 35.

1) A hinge device for appliances with top loading comprising a first fixing means (3) configured for fixation to a body (S) or framework of an appliance and pivotally connected, by means of a hinge pin (4), to a second fixing means (5) assigned to be fixed to an upper door (P) or hatch of the appliance to allow opening and closing strokes between extreme opening and closing conditions of said door with respect to the appliance where, in an operative condition, a rotation axis of said hinge pin (4) and a plane of the door in the closed condition are substantially horizontal, wherein the second fixing means (5) is provided with a first connection pin (6) parallel to and spaced from the hinge pin (4), wherein the first connection pin (6) is connected to an end of a transmission means (9) having at an opposite end a second connection pin (10) parallel to the first connection pin (6), wherein the second connection pin (10) is connected to a shaped body means (13) comprising at least a roll means (14) and a coupling means (16) for coupling to an end of a resilient means (17) of the hinge device acting at least in a direction according to the opening stroke in an opening direction of the upper door (P); wherein the first connection pin (6) is slidable in a slot means (35) of a shaped guide means (19) of the first fixing means (3) and substantially rectilinear and parallel to a path portion (21) delimited between a first extremity (22) and a second extremity (23) thereof (21) and having at least a recess means (24) placed between the first extremity (22) and the second extremity (23) where the roll means (14) abuts with said path portion (21) and moves along it in the opening stroke starting from the closed condition, in which the roll means (14) abuts the first extremity (22) until the roll means (14) reaches at least a metastable opening condition where the roll means (14) is in the at least one recess means (24) and abuts with one edge of said recess means (24), facing the second extremity (23) until, due to a thrust towards the opening direction sufficient to leave the recess means (24), the roll means (14) reaches the extreme opening condition, wherein the roll means (14) abuts against the second extremity (23) and vice versa in the closing stroke.

2) The device according to claim 1, wherein an average profile of the path portion (21) is substantially rectilinear and wherein the resilient means (17) through the coupling means (16) transmits to the shaped body means (13) an elastic force having a component acting in a direction according to a rotation in the opening direction and a component directed toward the path portion (21) and acting on the roll means (14) elastically pressing the roll means (14) towards the path portion (21) and said substantially rectilinear average profile is substantially parallel to said component acting in the direction according to the rotation in the opening direction.

3) The device according to claim 2, wherein the path portion (21) of the shaped guide means (19) is also provided with a protruding ramp means (25) placed close to the second extremity (23) where the roll means (14), reaching and running the protruding ramp means (25) in the opening stroke, damps, slows, or both damps and slows a speed of the closing motion.

4) The device according to claim 1, wherein the transmission means (9) comprises at least a connecting rod (27) having a first end directly connected to the first connection pin (6) and a second end directly or indirectly connected to the second connection pin (10).

5) The device according to claim 4, further comprising an arm means (29) having an extremity connected by means of an intermediate rotation pivot (30) to the second end of the connecting rod (27) and pivotally connected to the second connection pin (10).

6) The device according to claim to 5, wherein the arm means (29) comprises a strike gudgeon means (32) sliding in another slot means (33) substantially straight and carried out into or secured to the first fixing means (3) and substantially parallel to the path portion (21).

7) The device according to claim 6, further comprising a dampener means (39) having an extremity fixed to the first fixing means (3) and having a mobile extremity assigned to abut with the strike gudgeon means (32) at least in an end portion of the closing stroke or rotation.

8) Device according to claim 7, wherein the dampener means (39) is of a linear type and is substantially parallel to the other slot means (33).

9) The device according to claim 1, wherein the first fixing means (3) and the second fixing means (5) are made of punched and bent metal sheet and each having a pair of parallel ears for seats of the hinge pin (4) in the first fixing means and for seats of the hinge pin (4) and of the first connection pin (6) in the second fixing means.

10) The device according to claim 4, wherein the connecting rod (27) comprises a pair of elongated and rectilinear metal plates.

11) The device according to claim 5, wherein the shaped body means (13) and the arm means (29) are made of punched and “U” bent metal sheet and the arm means (29) partially contains the shaped body means (13).

12) The device according to claim 1, wherein the roll means (14) comprises a bushing or wheel rotatably engaged to a rotation pin fixed to the corresponding lateral faces of the shaped body means (13).

13) The device according to claim 1, wherein the shaped guide means (19) is a punched and bent metal sheet and the edge of the path portion (21) is sanded or polished.

14) The device according to claim 1, wherein the resilient means (17) consists of a helical spring acting in traction.
